(19) United States
(12) Patent Application Publication
(10) Pub. No.: US 2022/0190346 A1
(43) Pub. Date: Jun. 16, 2022

(54) LITHIUM-PROTECTING POLYMER COMPOSITE LAYER FOR A LITHIUM METAL SECONDARY BATTERY AND MANUFACTURING METHOD

(71) Applicant: Global Graphene Group, Inc., Dayton, OH (US)

(72) Inventor: Bor Z. Jang, Centerville, OH (US)

(21) Appl. No.: 17/121,435

(22) Filed: Dec. 14, 2020

(51) Int. Cl. H01M 4/62; H01M 10/052; H01M 4/60; H01M 4/36; H01M 4/139; H01M 4/04; H01M 10/42

(52) U.S. Cl. CPC H01M 4/628; H01M 10/052; H01M 4/602; H01M 2004/021; H01M 4/139; H01M 4/0404; H01M 10/4235; H01M 4/364

(57) ABSTRACT

A lithium secondary battery comprising a cathode, an anode, and an electrolyte or separator-electrolyte assembly disposed between the cathode and the anode, wherein the anode comprises: (a) an anode current collector; and (b) a thin layer of a high-elasticity polymer composite in ionic contact with the electrolyte and disposed between the anode current collector and the electrolyte wherein the polymer composite comprises from 0.01% to 95% by weight of a flame retardant additive dispersed in, dissolved in, or chemically bonded to an elastic polymer and wherein the polymer composite has a thickness from 2 nm to 100 μm, a fully recoverable tensile strain from 2% to 700%, and a lithium ion conductivity from 10⁻⁸ S/cm to 5×10⁻² S/cm.

### FIELD

The present disclosure relates to the field of rechargeable lithium metal battery and, in particular, to an anode-less rechargeable lithium metal battery having no lithium metal as an anode active material initially when the battery is made and a method of manufacturing same.

### BACKGROUND

Lithium-ion and lithium (Li) metal cells (including Lithium-sulfur cell, Li-air cell, etc.) are considered promising power sources for electric vehicle (EV), hybrid electric vehicle (HEV), and portable electronic devices, such as lap-top computers and mobile phones. Lithium metal has the highest capacity (3,861 mAh/g) compared to any other metal or metal-intercalated compound (except Li₄₄Si) as an anode active material. Hence, in general, rechargeable Li metal batteries have a significantly higher energy density than lithium ion batteries.

Historically, rechargeable lithium metal batteries were produced using non-lithiated compounds having high specific capacities, such as TiS₂, MoS₂, MnO₂, CoO₂ and V₂O₅, as the cathode active materials, which were coupled with a lithium metal anode. When the battery was discharged, lithium ions were dissolved from the lithium metal anode and transferred to the cathode through the electrolyte and, thus, the cathode became lithiated. Unfortunately, upon cycling, the lithium metal resulted in the formation of dendrites that ultimately caused unsafe conditions in the battery. As a result, the production of these types of secondary batteries was stopped in the early 1990's giving ways to lithium-ion batteries.

Even now, cycling stability and safety concerns remain the primary factors preventing the further commercialization of Li metal batteries for EV, HEV, and microelectronic device applications. These issues are primarily due to the high tendency for Li to form dendrite structures during repeated charge-discharge cycles or an overcharge, leading to internal electrical shorting and thermal runaway. Many attempts have been made to address the dendrite-related issues, as briefly summarized below:

Fauteux, et al. [D. Fauteux, et al., “Secondary Electrolytic Cell and Electrolytic Process,” U.S. Pat. No. 5,434,021, Jul. 18, 1995] applied to a metal anode a protective surface layer (e.g., a mixture of polynuclear aromatic and polyethylene oxide) that enables transfer of metal ions from the metal anode to the electrolyte and back. The surface layer is also electronically conductive so that the ions will be uniformly attracted back onto the metal anode during electrodeposition (i.e. during battery recharge). Alamgir, et al. [M. Alamgir, et al. “Solid polymer electrolyte batteries containing metallocenes,” U.S. Pat. No. 5,536,599, Jul. 16, 1996] used ferrocenes to prevent chemical overcharge and dendrite formation in a solid polymer electrolyte-based rechargeable battery.

Skotheim [T. A. Skotheim, “Stabilized Anode for Lithium-Polymer Battery,” U.S. Pat. No. 5,648,187 (Jul. 15, 1997); U.S. Pat. No. 5,961,672 (Oct. 5, 1999)] provided a Li metal anode that was stabilized against the dendrite formation by the use of a vacuum-evaporated thin film of a Li ion-conducting polymer interposed between the Li metal anode and the electrolyte. Skotheim, et al. [T. A. Skotheim, et al. “Lithium Anodes for Electrochemical Cells,” U.S. Pat. No. 6,733,924 (May 11, 2004); U.S. Pat. No. 6,797,428 (Sept. 28, 2004); U.S. Pat. No. 6,936,381 (Aug. 30, 2005); and U.S. Pat. No. 7,247,408 (Jul. 24, 2007)] further proposed a multilayer anode structure consisting of a Li metal-based first layer, a second layer of a temporary protective metal (e.g., Cu, Mg, and Al), and a third layer that is composed of at least one layer (typically 2 or more layers) of a single ion-conducting glass, such as lithium silicate and lithium phosphate, or polymer. It is clear that such an anode structure, consisting of at least 3 or 4 layers, is too complex and too costly to make and use.

Protective coatings for Li anodes, such as glassy surface layers of LiI—Li₃PO₄—P₂S₅, may be obtained from plasma assisted deposition [S. J. Visco, et al., “Protective Coatings for Negative Electrodes,” U.S. Pat. No. 6,025,094 (Feb. 15, 2000)]. Complex, multi-layer protective coatings were also proposed by Visco, et al. [S. J. Visco, et al., “Protected Active Metal Electrode and Battery Cell Structures with Non-aqueous Interlayer Architecture,” U.S. Pat. No. 7,282,295 (Oct. 16, 2007); U.S. Pat. No. 7,282,296 (Oct. 16, 2007); and U.S. Pat. No. 7,282,302 (Oct. 16, 2007)].

Despite these earlier efforts, no rechargeable Li metal batteries have yet succeeded in the market place. This is likely due to the notion that these prior art approaches still have major deficiencies. For instance, in several cases, the anode or electrolyte structures are too complex. In others, the materials are too costly or the processes for making these materials are too laborious or difficult. Solid electrolytes typically have a low lithium ion conductivity, are difficult to produce and difficult to implement into a battery.

Furthermore, solid electrolyte, as the sole electrolyte in a cell or as an anode-protecting layer (interposed between the lithium film and the liquid electrolyte) does not have and cannot maintain a good contact with the lithium metal. This effectively reduces the effectiveness of the electrolyte to support dissolution of lithium ions (during battery discharge), transport lithium ions, and allowing the lithium ions to re-deposit back to the lithium anode (during battery recharge).

Another major issue associated with the lithium metal anode is the continuing reactions between electrolyte and lithium metal, leading to repeated formation of “dead lithium-containing species” that cannot be re-deposited back to the anode and become isolated from the anode. These reactions continue to irreversibly consume electrolyte and lithium metal, resulting in rapid capacity decay. In order to compensate for this continuing loss of lithium metal, an excessive amount of lithium metal (3-5 times higher amount than what would be required) is typically implemented at the anode when the battery is made. This adds not only costs but also a significant weight and volume to a battery, reducing the energy density of the battery cell. This important issue has been largely ignored and there has been no plausible solution to this problem in battery industry.

Clearly, an urgent need exists for a simpler, more cost-effective, and easier to implement approach to preventing Li metal dendrite-induced internal short circuit and thermal runaway problems in Li metal batteries, and to reducing or eliminating the detrimental reactions between lithium metal and the electrolyte.

Hence, an object of the present disclosure was to provide an effective way to overcome the lithium metal dendrite and reaction problems in all types of Li metal batteries having a lithium metal anode. A specific object of the present disclosure was to provide a lithium metal cell that exhibits a high specific capacity, high specific energy, high degree of safety, and a long and stable cycle life.

### SUMMARY

The present disclosure provides a lithium secondary battery comprising a cathode, an anode, and an electrolyte or separator-electrolyte assembly disposed between the cathode and the anode, wherein the anode comprises: (a) an anode current collector; and (b) a thin layer of a high-elasticity polymer composite in ionic contact with the electrolyte and disposed between the anode current collector and the electrolyte wherein the polymer composite comprises from 0.01% to 95% by weight (preferably 1% to 50%) of a flame retardant dispersed or dissolved in an elastic polymer and the polymer composite has a thickness from 1 nm to 100 μm (preferably <10 μm), a fully recoverable tensile strain from 2% to 700%, and a lithium ion conductivity from 10⁻⁸ S/cm to 5×10⁻² S/cm.

In certain embodiments, the anode in the lithium secondary battery has an amount of lithium or lithium alloy as an anode active material supported by the anode current collector. In certain other embodiments, initially the anode has no lithium or lithium alloy as an anode active material supported by said anode current collector when the battery is made and prior to a charge or discharge operation of the battery. This latter configuration is referred to as an anode-less lithium battery.

The flame retardant additive may be selected from a halogenated flame retardant (e.g., a brominated flame retardant), phosphorus-based flame retardant, melamine flame retardant, metal hydroxide flame retardant, silicon-based flame retardant, phosphate flame retardant, biomolecular flame retardant, or a combination thereof.

In certain embodiments, the elastic polymer composite comprises reactive type flame retardant (flame-retardant group becomes part of the polymer chain structure after polymerization or crosslinking), additive type flame retardant (additive simply dispersed in the polymer matrix), or both types. For instance. the elastic polymer composite may comprise a flame retardant chemical group that is bonded to polysiloxane, which is elastic.

The electrolyte in the battery may be selected from an organic liquid electrolyte, ionic liquid electrolyte, polymer gel electrolyte, solid-state electrolyte (solid polymer or inorganic electrolyte), quasi-solid electrolyte having a lithium salt dissolved in an organic or ionic liquid with a lithium salt concentration higher than 2.0 M, hybrid or composite electrolyte, or a combination thereof.

The inorganic solid electrolyte material may be selected from an oxide type, sulfide type, hydride type, halide type, borate type, phosphate type, lithium phosphorus oxynitride (LiPON), Garnet-type, lithium superionic conductor (LISICON), sodium superionic conductor (NAS ICON), or a combination thereof. A porous separator (lithium ion-permeable membrane) may not be necessary if the electrolyte is a solid-state electrolyte.

The anode current collector may be selected from, for instance, a Cu foil, a Cu-coated polymer film, a sheet of Ni foam, a porous layer of nano-filaments, such as graphene sheets, carbon nanofibers, carbon nano-tubes, etc.

High-elasticity polymer refers to a polymer, typically a lightly cross-linked polymer, which exhibits an elastic deformation that is at least 2% (preferably at least 5%) when measured under uniaxial tension. In the field of materials science and engineering, the “elastic deformation” is defined as a deformation of a material (when being mechanically stressed) that is essentially fully recoverable upon release of the load and the recovery process is essentially instantaneous (no or little time delay). The elastic deformation is more preferably greater than 10%, even more preferably greater than 30%, further more preferably greater than 50%, and still more preferably greater than 100%. The elasticity of the elastic polymer alone (without any additive dispersed therein) can be as high as 1,000%. However, the elasticity can be significantly reduced if a certain amount of additive is added into the polymer. Depending upon the type and proportion of the additive incorporated, the reversible elastic deformation is typically reduced to the range of 2%-500%, more typically 2%-300%.

In some preferred embodiments, the high-elasticity polymer contains a lightly cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof, in the cross-linked network of polymer chains. These network or cross-linked polymers exhibit a unique combination of a high elasticity (high elastic deformation strain) and high lithium-ion conductivity.

In certain preferred embodiments, the high-elasticity polymer contains a lightly cross-linked network polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, or a combination thereof.

The elastic polymer may comprise an elastomer selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, polyurethane, urethane-urea copolymer, urethane-acrylic copolymer, a copolymer thereof, a sulfonated version thereof, or a combination thereof.

In some embodiments, the high-elasticity polymer comprises an elastomer selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

In some embodiments, the elastic polymer comprises an ultra-high molecular weight polymer, having a molecular weight greater than 500,000 g/mole, selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

The elastic polymer may further comprise from 0.1% to 50% by weight of a lithium ion-conducting additive, which is different from the inorganic filler.

This high-elasticity polymer layer may be a thin film disposed against a surface of an anode current collector. The anode contains a current collector without a lithium metal or any other anode active material, such as graphite or Si particles, when the battery cell is manufactured. Such a battery cell having an initially lithium metal-free anode is commonly referred to as an “anode-less” lithium battery. The lithium ions that are required for shuttling back and forth between the anode and the cathode are initially stored in the cathode active materials (e.g. Li in LiMn₂O₄ and LiMPO₄, where M=Ni, Co, F, Mn, etc.). During the first battery charge procedure, lithium ions (Li⁺) come out of the cathode active material, move through the electrolyte and then through the presently disclosed protective high-elasticity polymer layer and get deposited on a surface of the anode current collector. As this charging procedure continues, more lithium ions get deposited onto the current collector surface, eventually forming a lithium metal film or coating.

During the subsequent discharge, this lithium film or coating layer decreases in thickness due to dissolution of lithium into the electrolyte to become lithium ions, creating a gap between the current collector and the protective layer if the protective layer were not elastic. Such a gap would make the re-deposition of lithium ions back to the anode impossible during a subsequent recharge procedure. We have observed that the high-elasticity polymer is capable of expanding or shrinking congruently or conformably with the anode layer. This capability helps to maintain a good contact between the current collector (or the lithium film itself) and the protective layer, enabling the re-deposition of lithium ions without interruption.

In certain embodiments, the high-elasticity polymer further contains a reinforcement material dispersed therein wherein the reinforcement material is selected from a polymer fiber, a glass fiber, a ceramic fiber or nano-flake (e.g. nano clay flakes), a graphene sheet, a carbon fiber, a graphite fiber, a carbon nano-fiber, a graphite nano-fiber, a carbon nanotube, a graphite particle, an expanded graphite flake, an acetylene black particle, or a combination thereof. The reinforcement material preferably has a thickness or diameter less than 100 nm.

The high-elasticity polymer composite may further comprise a lithium salt (as a lithium ion-conducting additive) dispersed in the polymer wherein the lithium salt may be preferably selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

At the anode side, preferably and typically, the high-elasticity polymer composite for the protective layer has a lithium ion conductivity no less than 10⁻⁵ S/cm, more preferably no less than 10⁻⁴ S/cm, and most preferably no less than 10⁻³ S/cm. Some of the selected polymers exhibit a lithium-ion conductivity greater than 10⁻² S/cm.

In some embodiments, the high-elasticity polymer composite further comprises a lithium ion-conducting additive dispersed in a high-elasticity polymer matrix material, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4.

The high-elasticity polymer may form a mixture, blend, co-polymer, or semi-interpenetrating network (semi-IPN) with an electron-conducting polymer selected from polyaniline, polypyrrole, polythiophene, polyfuran, a bi-cyclic polymer, derivatives thereof (e.g. sulfonated versions), or a combination thereof.

In some embodiments, the high-elasticity polymer forms a mixture, blend, or semi-IPN with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof. Sulfonation is herein found to impart improved lithium ion conductivity to a polymer.

The cathode active material may be selected from an inorganic material, an organic material, a polymeric material, or a combination thereof. The inorganic material may be selected from a metal oxide, metal phosphate, metal silicide, metal selenide (e.g. lithium polyselides for use in a Li-Se cell), metal sulfide (e.g. lithium polysulfide for use in a Li-S cell), or a combination thereof. Preferably, these cathode active materials contain lithium in their structures; otherwise the cathode must contain a lithium source.

The inorganic cathode material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The cathode active material layer may contain a metal oxide containing vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The cathode active material is preferably in a form of nano particle (spherical, ellipsoidal, and irregular shape), nano wire, nano fiber, nano tube, nano sheet, nano belt, nano ribbon, nano disc, nano platelet, or nano horn having a thickness or diameter less than 100 nm. These shapes can be collectively referred to as “particles” unless otherwise specified or unless a specific type among the above species is desired. Further preferably, the cathode active material has a dimension less than 50 nm, even more preferably less than 20 nm, and most preferably less than 10 nm. In some embodiments, one particle or a cluster of particles may be coated with or embraced by a layer of carbon disposed between the particle(s) and/or a high-elasticity polymer layer (an encapsulating shell).

The cathode layer may further contain a graphite, graphene, or carbon material mixed with the cathode active material particles. The carbon or graphite material is selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, or a combination thereof. Graphene may be selected from pristine graphene, graphene oxide, reduced graphene oxide, graphene fluoride, hydrogenated graphene, nitrogenated graphene, functionalized graphene, etc.

The cathode active material particles may be coated with or embraced by a conductive protective coating, selected from a carbon material, graphene, electronically conductive polymer, conductive metal oxide, or conductive metal coating.

The disclosure also provides an anode electrode for use in a lithium metal battery, the anode comprising (a) an anode current collector and an optional lithium metal or lithium alloy supported on the anode current collector; and (b) a thin layer of a high-elasticity polymer composite in contact with the anode current collector or the lithium metal or lithium metal alloy (when present) wherein the polymer composite comprises from 0.01% to 50% by weight of a flame retardant dispersed in an elastic polymer and the polymer composite has a thickness from 1 nm to 10 μm, a fully recoverable tensile strain from 2% to 500%, and a lithium ion conductivity from 10⁻⁸ S/cm to 5×10⁻² S/cm.

The disclosure also provides a method of manufacturing an anode electrode for a lithium battery, the method comprising: (A) providing an anode current collector having two primary surfaces; and (B) depositing a thin layer of a high-elasticity polymer composite onto at least one of the two primary surfaces of the anode current collector wherein the polymer composite comprises from 0.01% to 95% by weight of a flame retardant dispersed in an elastic polymer and the polymer composite has a thickness from 1 nm to 10 μm, a fully recoverable tensile strain from 2% to 700%, and a lithium ion conductivity from 10⁻⁸ S/cm to 5×10⁻² S/cm.

In certain embodiments, the method further comprises a step (C) of depositing a desired amount of lithium metal or lithium metal alloy on at least one of the two primary surfaces before step (B). The lithium metal or lithium metal alloy may be in the form of a foil, film, coating or powder particles.

In some embodiments, step (B) comprises (i) dispersing particles of the flame retardant in a liquid reactive mass of the elastic polymer precursor (e.g. reactive monomers or oligomer) to form a slurry; (ii) dispensing and depositing the liquid reactive mass onto the at least one primary surface; and (iii) curing the reactive mass to form this layer of high-elasticity polymer composite.

The method may further comprise combining the anode, an electrolyte and a cathode electrode to form a lithium battery cell.

Preferably, the high-elasticity polymer composite has a lithium ion conductivity from 1×10⁻⁵ S/cm to 5×10⁻² S/cm. In some embodiments, the high-elasticity polymer composite has a recoverable tensile strain from 10% to 300% (more preferably >30%, and further more preferably >50%).

In certain embodiments, the procedure of providing a high-elasticity polymer contains providing a mixture/blend/composite of an elastic polymer with an elastomer, an electronically conductive polymer (e.g. polyaniline, polypyrrole, polythiophene, polyfuran, a bi-cyclic polymer, a sulfonated derivative thereof, or a combination thereof), a lithium-ion conducting material, a reinforcement material (e.g. carbon nanotube, carbon nano-fiber, and/or graphene), or a combination thereof.

In this mixture/blend/composite, the lithium ion-conducting material is dispersed in the high-elasticity polymer and is preferably selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4.

In some embodiments, the lithium ion-conducting material is dispersed in the high-elasticity polymer and is selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

### BRIEF DESCRIPTION OF THE DRAWINGS

FIG. 1 Schematic of a prior art lithium metal battery cell, containing an anode layer (a thin Li foil or Li coating deposited on a surface of a current collector, Cu foil), a porous separator, and a cathode active material layer, which is composed of particles of a cathode active material, a conductive additive (not shown) and a resin binder (not shown). A cathode current collector supporting the cathode active layer is also shown.

FIG. 2 Schematic of a presently disclosed lithium metal battery cell (upper diagram) containing an anode current collector (e.g. Cu foil) but no anode active material (when the cell is manufactured or in a fully discharged state), a high-elasticity polymer composite-based anode-protecting layer, a porous separator, and a cathode active material layer, which is composed of particles of a cathode active material, a conductive additive (not shown) and a resin binder (not shown). A cathode current collector supporting the cathode active layer is also shown. The lower diagram shows a thin lithium metal layer deposited between the Cu foil and the polymer composite layer when the battery is in a charged state.

FIG. 3(A) Schematic of a polymer composite layer wherein a flame retardant additive is uniformly dispersed in a matrix of elastic polymer according to some embodiments of the present disclosure;

FIG. 3(B) Schematic of a polymer composite layer wherein a flame retardant additive is preferentially dispersed near one surface (e.g. facing the anode current collector) of an elastic polymer layer; the opposing surface has a lower or zero concentration of the a flame retardant additive, according to some embodiments of the present disclosure.

FIG. 4(A) Representative tensile stress-strain curves of lightly cross-linked ETPTA polymers.

FIG. 4(B) The specific intercalation capacity curves of two lithium cells, each having a cathode containing graphene-embraced LiV₂O₅ particles (one cell having an ETPTA polymer composite protective layer and the other does not have a polymer composite-based protection layer).

FIG. 5 The discharge capacity curves of two coin cells having a NCM532-based of cathode active materials: (1) having a protective layer of high-elasticity PETEA polymer composite containing a flame retardant additive; and (2) no anode-protecting layer.

### DESCRIPTION OF THE PREFERRED EMBODIMENTS

This disclosure is related to a lithium secondary battery, which is preferably based on an organic electrolyte, a polymer gel electrolyte, an ionic liquid electrolyte, a quasi-solid electrolyte, or a solid-state electrolyte. The shape of a lithium secondary battery can be cylindrical, square, button-like, etc. The present disclosure is not limited to any battery shape or configuration or any type of electrolyte.

The present disclosure provides a lithium secondary battery comprising a cathode, an anode, and an electrolyte or separator-electrolyte assembly disposed between the cathode and the anode, wherein the anode comprises: (a) an anode current collector; and (b) a thin layer of a high-elasticity polymer composite in ionic contact with the electrolyte and disposed between the anode current collector and the electrolyte wherein the polymer composite comprises from 0.01% to 95% by weight of a flame retardant dispersed or dissolved in an elastic polymer (or chemically bonded to the elastic polymer) and the polymer composite has a thickness from 1 nm to 100 μm (preferably <10 μm), a fully recoverable tensile strain from 2% to 700%, and a lithium ion conductivity from 10⁻⁸ S/cm to 5×10⁻² S/cm.

In certain embodiments, the anode in the lithium secondary battery has an amount of lithium or lithium alloy as an anode active material supported by the anode current collector. In certain other embodiments, initially the anode has no lithium or lithium alloy as an anode active material supported by said anode current collector when the battery is made and prior to a charge or discharge operation of the battery. This latter configuration is referred to as an anode-less lithium battery. In certain embodiments the battery can be manufactured with a lithium metal film between the high-elasticity polymer composite film and the anode current collector.

The current collector may be a Cu foil, a layer of Ni foam, a porous layer of nano-filaments, such as graphene sheets, carbon nanofibers, carbon nano-tubes, etc. forming a 3D interconnected network of electron-conducting pathways.

We have discovered that this protective layer provides several unexpected benefits: (a) the formation of dendrite has been essentially eliminated; (b) uniform deposition of lithium back to the anode side is readily achieved during battery charging; (c) the layer ensures smooth and uninterrupted transport of lithium ions from/to the anode current collector surface (or the lithium film deposited thereon during the battery operations) and through the interface between the current collector (or the lithium film deposited thereon) and the protective layer with minimal interfacial resistance; (d) cycle stability can be significantly improved and cycle life increased; and (e) flammability of the battery cell has been reduced or eliminated, resulting in significantly improved battery safety.

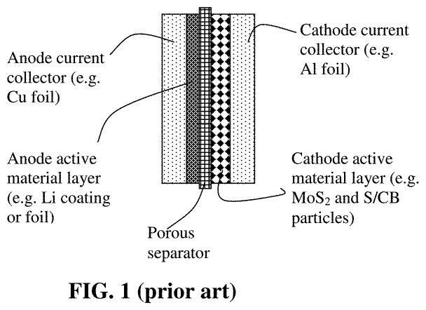

In a conventional lithium metal cell, as illustrated in FIG. 1, the anode active material (lithium) is deposited in a thin film form or a thin foil form directly onto an anode current collector (e.g. a Cu foil) before this anode and a cathode are combined to form a cell. The battery is a lithium metal battery, lithium sulfur battery, lithium-selenium battery, etc. As previously discussed in the Background section, these lithium secondary batteries have the dendrite-induced internal shorting and “dead lithium” issues at the anode.

We have solved these challenging issues that have troubled battery designers and electrochemists alike for more than 30 years by developing and implementing a new anode-protecting layer between the anode current collector and the electrolyte (or electrolyte/separator). This protective layer comprises a high-elasticity polymer composite having a recoverable (elastic) tensile strain no less than 2% (preferably no less than 5%, and further preferably from 10% to 500%) under uniaxial tension and a lithium ion conductivity no less than 10⁻⁸ S/cm at room temperature (preferably and more typically from 1×10⁻⁵ S/cm to 5 ×10⁻² S/cm).

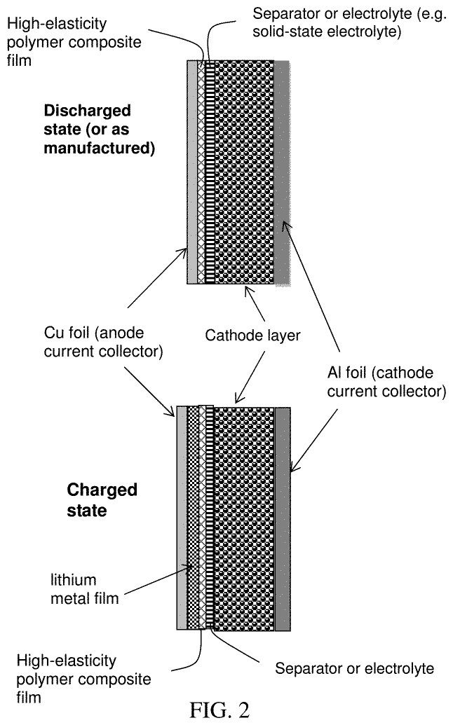

As schematically shown in FIG. 2, one embodiment of the present disclosure is a lithium metal battery cell containing an anode current collector (e.g. Cu foil), a high-elasticity polymer composite-based anode-protecting layer, a porous separator, and a cathode active material layer, which is composed of particles of a cathode active material, a conductive additive (not shown) and a resin binder (not shown). A cathode current collector (e.g. Al foil) supporting the cathode active layer is also shown in FIG. 2.

High-elasticity polymer material refers to a material (polymer or polymer composite) that exhibits an elastic deformation of at least 2% when measured under uniaxial tension. In the field of materials science and engineering, the “elastic deformation” is defined as a deformation of a material (when being mechanically stressed) that is essentially fully recoverable and the recovery is essentially instantaneous upon release of the load. The elastic deformation is preferably greater than 5%, more preferably greater than 10%, further more preferably greater than 30%, and still more preferably greater than 100% (up to 500%).

It may be noted that FIG. 2 shows a lithium battery that initially does not contain a lithium foil or lithium coating at the anode (only an anode current collector, such as a Cu foil or a graphene/CNT mat) when the battery is made. The needed lithium to be bounced back and forth between the anode and the cathode is initially stored in the cathode active material (e.g. lithium vanadium oxide LiₓV₂O₅, instead of vanadium oxide, V₂O₅; or lithium polysulfide, instead of sulfur). During the first charging procedure of the lithium battery (e.g. as part of the electrochemical formation process), lithium comes out of the cathode active material, migrates to the anode side, passes through the high-elasticity polymer composite layer and deposits on the anode current collector. The presence of the presently disclosed high-elasticity polymer composite layer enables the uniform deposition of lithium ions on the anode current collector surface. Such a battery configuration avoids the need to have a layer of lithium foil or coating being present during battery fabrication. Bare lithium metal is highly sensitive to air moisture and oxygen and, thus, is more challenging to handle in a real battery manufacturing environment.

This strategy of pre-storing lithium in the lithiated (lithium-containing) cathode active materials, such as LiₓV₂O₅ and Li₂Sₓ, makes all the materials safe to handle in a real manufacturing environment. Cathode active materials, such as LiₓV₂O₅ and Li₂Sₓ, are typically not air-sensitive.

As the charging procedure continues, more lithium ions get to deposit onto the anode current collector, forming a lithium metal film or coating. During the subsequent discharge procedure, this lithium film or coating layer decreases in thickness due to dissolution of lithium into the electrolyte to become lithium ions, creating a gap between the current collector and the protective layer if the protective layer were not elastic. Such a gap would make the re-deposition of lithium ions back to the anode impossible during a subsequent recharge procedure. We have observed that the high-elasticity polymer is capable of expanding or shrinking congruently or conformably with the anode layer. This capability helps to maintain a good contact between the current collector (or the lithium film deposited on the current collector surface) and the protective layer, enabling the re-deposition of lithium ions without interruption.

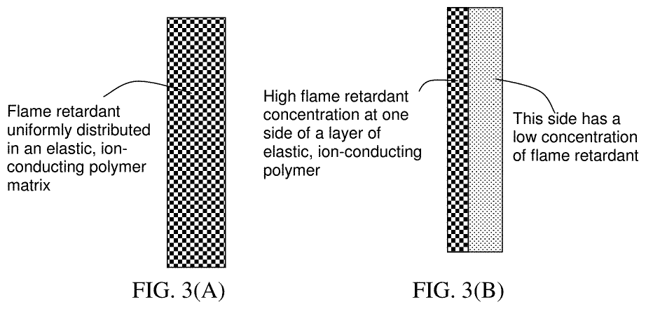

FIG. 3(A) schematically shows a polymer composite layer wherein a flame retardant additive is uniformly dispersed in a matrix of an elastic polymer according to some embodiments of the present disclosure. According to some other embodiments of the present disclosure, FIG. 3(B) schematically shows a polymer composite layer wherein a flame retardant additive is preferentially dispersed near one surface (e.g. facing the anode current collector) of an elastic polymer layer; the opposing surface has a lower or zero concentration of the flame retardant additive. This latter structure has the advantages that the high-concentration portion, being strong and tough, provides a fire-fighting capability and a lithium dendrite-stopping capability while other portion of the layer remains highly elastic to maintain good contacts with neighboring layers (e.g. solid electrolyte on one side and lithium metal on the other) for reduced interfacial impedance.

Flame-retardant additives are intended to inhibit or stop polymer pyrolysis and combustion processes by interfering with the various mechanisms involved—heating, ignition, and propagation of thermal degradation.

The flame retardant additive may be selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

There is no limitation on the type of flame retardant that can be physically or chemically incorporated into the elastic polymer. The main families of flame retardants are based on compounds containing: Halogens (Bromine and Chlorine), Phosphorus, Nitrogen, Intumescent

Systems, Minerals (based on aluminum and magnesium), and others (e.g. Borax, Sb₂O₃, and nanocomposites). Antimony trioxide is a good choice, but other forms of antimony such as the pentoxide and sodium antimonate may also be used.

One may use the reactive types (being chemically bonded to or becoming part of the polymer structure) and additive types (simply dispersed in the polymer matrix). For instance, reactive polysiloxane can chemically react with EPDM type elastic polymer and become part of the crosslinked network polymer. It may be noted that flame-retarding group modified polysiloxane itself is an elastic polymer composite containing a flame retardant according to an embodiment of instant disclosure. Both reactive and additive types of flame retardants can be further separated into several different classes:
1) Minerals: Examples include aluminum hydroxide (ATH), magnesium hydroxide (MDH), huntite and hydromagnesite, various hydrates, red phosphorus and boron compounds (e.g. borates).
2) Organo-halogen compounds: This class includes organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA), and hexabromocyclododecane (HBCD).
3) Organophosphorus compounds: This class includes organophosphates such as triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl) dichloroisopentyldiphosphate (V6).
4) Organic compounds such as carboxylic acid and dicarboxylic acid

The mineral flame retardants mainly act as additive flame retardants and do not become chemically attached to the surrounding system (the polymer). Most of the organohalogen and organophosphate compounds also do not react permanently to attach themselves into the polymer. Certain new non halogenated products, with reactive and non-emissive characteristics have been commercially available as well.

Preferably, the electrolyte used in the lithium cell is selected from organic liquid electrolyte, polymer gel electrolyte, quasi-solid electrolyte, or solid-state electrolyte (polymer solid, inorganic solid, or composite solid). The inorganic solid electrolyte material may be selected from an oxide type (e.g. perovskite-type), sulfide type, hydride type, halide type, borate type, phosphate type, lithium phosphorus oxynitride (LiPON), Garnet-type, lithium superionic conductor (LISICON), sodium superionic conductor (NASICON), or a combination thereof.

The inorganic solid electrolytes include,but are not limited to, perovskite-type, NASICON-type, garnet-type and sulfide-type materials. A representative and well-known perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in an elastic polymer, does riot suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋₋ₓ(PO₄)₃(M=Al, Cr, Ga, Fe, Sc, In, Lu, Y or La). Al substitution has been demonstrated to be the most effective solid state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂, (M=W or Te), a broad series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ ounds have a high ionic conductivity of 1.02×10⁻³ S/cm at room temperature.

The sulfide-type solid electrolytes include the Li₂S—SiS₂ system. The highest reported conductivity in this type of material is 6.9×10⁻⁴ S/cm, which was achieved by doping the Li₂S—SiS₂ system with Li₃PO₄. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer.

The high-elasticity polymer should have a high elasticity (elastic deformation strain value >2%). An elastic deformation is a deformation that is fully recoverable and the recovery process is essentially instantaneous (no significant time delay). The high-elasticity polymer can exhibit an elastic deformation from 5% up to 1,000% (10 times of its original length), more typically from 10% to 800%, and further more typically from 50% to 500%, and most typically and desirably from 70% to 300%. It may be noted that although a metal typically has a high ductility (i.e. can be extended to a large extent without breakage), the majority of the deformation is plastic deformation (non-recoverable) and only a small amount of elastic deformation (typically <1% and more typically <0.2%).

In some preferred embodiments, the high-elasticity polymer contains a lightly cross-linked network polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof, in the cross-linked network of polymer chains. These network or cross-linked polymers exhibit a unique combination of a high elasticity (high elastic deformation strain) and high lithium-ion conductivity.

In certain preferred embodiments, the high-elasticity polymer contains a lightly cross-linked network polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, or a combination thereof.

Typically, a high-elasticity polymer is originally in a monomer or oligomer states that can be cured to form a cross-linked polymer that is highly elastic. Prior to curing, these polymers or oligomers are soluble in an organic solvent to form a polymer solution. An ion-conducting or electron-conducting additive may be added to this solution to form a suspension. This solution or suspension can then be formed into a thin layer of polymer precursor on a surface of an anode current collector. The polymer precursor (monomer or oligomer and initiator) is then polymerized and cured to form a lightly cross-linked polymer. This thin layer of polymer may be tentatively deposited on a solid substrate (e.g. surface of a polymer or glass), dried, and separated from the substrate to become a free-standing polymer layer. This free-standing layer is then laid on a lithium foil/coating or implemented between a lithium film/coating and electrolyte or separator. Polymer layer formation can be accomplished by using one of several procedures well-known in the art; e.g. spraying, spray-painting, printing, coating, extrusion-based film-forming, casting, etc.

For instance, ethoxylated trimethylopropane triacrylate monomer (ETPTA, Mw=428, chemical formula given below), along with an initiator, can be dissolved in an organic solvent, such as ethylene carbonate (EC) or diethyl carbonate (DEC). Then, the ETPTA monomer/solvent/initiator solution may be cast to form ETPTA a monomer/initiator layer on a glass surface. The layer can then be thermally cured to obtain a thin layer of a high-elasticity polymer. The polymerization and cross-linking reactions of this monomer can be initiated by a radical initiator derived from benzoyl peroxide (BPO) or AIBN through thermal decomposition of the initiator molecule. The ETPTA monomer has the following chemical formula:

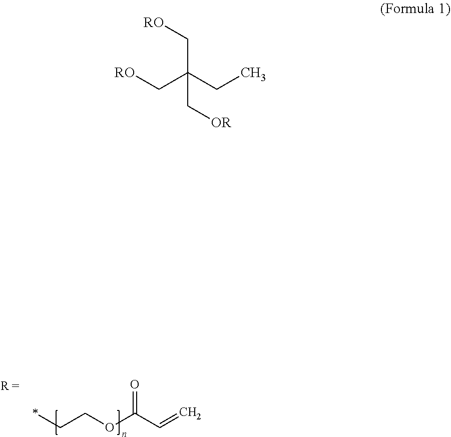

As another example, the high-elasticity polymer for anode lithium foil/coating protection may be based on cationic polymerization and cross-linking of the cyanoethyl polyvinyl alcohol (PVA-CN, Formula 2) in succinonitrile (SN).

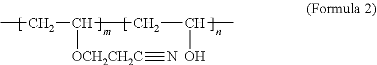

The procedure may begin with dissolving PVA-CN in succinonitrile (NCCH₂CH₂CN) to form a mixture solution. This is followed by adding an initiator into the mixture solution. For instance, LiPF₆ can be added into the PVA-CN/SN mixture solution at a weight ratio (selected from the preferred range from 20:1 to 2:1) to form a precursor solution. Then, the solution may be deposited to form a thin layer of reacting mass, PVA-CN/LiPF₆, which is subsequently heated at a temperature (e.g. from 75 to 100° C.) for 2 to 8 hours to obtain a high-elasticity polymer. During this process, cationic polymerization and cross-linking of cyano groups on the PVA-CN may be initiated by PF₅, which is derived from the thermal decomposition of LiPF₆ at such an elevated temperature.

It is essential for these materials to form a lightly cross-linked network of polymer chains. In other words, the network polymer or cross-linked polymer should have a relatively low degree of cross-linking or low cross-link density to impart a high elastic deformation.

The cross-link density of a cross-linked network of polymer chains may be defined as the inverse of the molecular weight between cross-links (Mc). The cross-link density can be determined by the equation, Mc=ρRT/Ge, where Ge is the equilibrium modulus as determined by a temperature sweep in dynamic mechanical analysis, ρ is the physical density, R is the universal gas constant in J/mol*K and T is absolute temperature in K. Once Ge and ρ are determined experimentally, then Mc and the cross-link density can be calculated.

The magnitude of Mc may be normalized by dividing the Mc value by the molecular weight of the characteristic repeat unit in the cross-link chain or chain linkage to obtain a number, Nc, which is the number of repeating units between two cross-link points. We have found that the elastic deformation strain correlates very well with Mc and Nc. The elasticity of a cross-linked polymer derives from a large number of repeating units (large Nc) between cross-links. The repeating units can assume a more relax conformation (e.g. random coil) when the polymer is not stressed. However, when the polymer is mechanically stressed, the linkage chain uncoils or gets stretched to provide a large deformation. A long chain linkage between cross-link points (larger Nc) enables a larger elastic deformation. Upon release of the load, the linkage chain returns to the more relaxed or coiled state. During mechanical loading of a polymer, the cross-links prevent slippage of chains that otherwise form plastic deformation (non-recoverable).

Preferably, the Nc value in a high-elasticity polymer is greater than 5, more preferably greater than 10, further more preferably greater than 100, and even more preferably greater than 200. These Nc values can be readily controlled and varied to achieve different elastic deformation values by using different cross-linking agents with different functionalities, and by designing the polymerization and cross-linking reactions to proceed at different temperatures for different periods of time.

Alternatively, Mooney-Rilvin method may be used to determine the degree of cross-linking. Crosslinking also can be measured by swelling experiments. In a swelling experiment, the crosslinked sample is placed into a good solvent for the corresponding linear polymer at a specific temperature, and either the change in mass or the change in volume is measured. The higher the degree of crosslinking, the less swelling is attainable. Based on the degree of swelling, the Flory Interaction Parameter (which relates the solvent interaction with the sample, Flory Huggins Eq.), and the density of the solvent, the theoretical degree of crosslinking can be calculated according to Flory's Network Theory. The Flory-Rehner Equation can be useful in the determination of cross-linking.

The high-elasticity polymer may contain a simultaneous interpenetrating network (SIN) polymer, wherein two cross-linking chains intertwine with each other, or a semi-interpenetrating network polymer (semi-IPN), which contains a cross-linked polymer and a linear polymer. An example of semi-IPN is an UV-curable/polymerizable trivalent/monovalent acrylate mixture, which is composed of ethoxylated trimethylolpropane triacrylate (ETPTA) and ethylene glycol methyl ether acrylate (EGMEA) oligomers. The ETPTA, bearing trivalent vinyl groups, is a photo (UV)-crosslinkable monomer, capable of forming a network of cross-linked chains. The EGMEA, bearing monovalent vinyl groups, is also UV-polymerizable, leading to a linear polymer with a high flexibility due to the presence of the oligomer ethylene oxide units. When the degree of cross-linking of ETPTA is moderate or low, the resulting ETPTA/EGMEA semi-IPN polymer provides good mechanical flexibility or elasticity and reasonable mechanical strength. The lithium-ion conductivity of this polymer is in the range from 10⁻⁴ to 5×10⁻³ S/cm.

The aforementioned high-elasticity polymers (with the flame retardant dispersed therein) may be used alone to protect the lithium foil/coating layer at the anode. Alternatively, the high-elasticity polymer can be mixed with a broad array of elastomers, electrically conducting polymers, lithium ion-conducting materials, and/or strengthening materials (e.g. carbon nanotube, carbon nano-fiber, or graphene sheets).

A broad array of elastomers can be used alone as an elastic polymer or mixed with a high-elasticity polymer to form a blend, co-polymer, or interpenetrating network that encapsulates the cathode active material particles. The elastomeric material may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The urethane-urea copolymer film usually consists of two types of domains, soft domains and hard ones. Entangled linear backbone chains consisting of poly (tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

In some embodiments, a high-elasticity polymer can form a polymer matrix composite containing a lithium ion-conducting additive dispersed in the high-elasticity polymer matrix material, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4.

In some embodiments, the high-elasticity polymer can be mixed with a lithium ion-conducting additive, which contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

The high-elasticity polymer may form a mixture, blend, or semi-interpenetrating network with an electron-conducting polymer selected from polyaniline, polypyrrole, polythiophene, polyfuran, a bi-cyclic polymer, derivatives thereof (e.g. sulfonated versions), or a combination thereof.

In some embodiments, the high-elasticity polymer may form a mixture, co-polymer, or semi-interpenetrating network with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a derivative thereof (e.g. sulfonated versions), or a combination thereof.

These lithium ion-conducting polymers, if having a molecular weight greater than 500,000 g/mole, can have sufficient amounts of physical entanglements of polymer chains that impart elasticity to the polymer, even though these polymers are not crosslinked. Thus, the elastic polymer per se may comprise an ultra-high molecular weight polymer, having a molecular weight greater than 500,000 g/mole, selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

Unsaturated rubbers that can be used as an elastic polymer include natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR),

Some elastomers are saturated rubbers that cannot be cured by sulfur vulcanization; they are made into a rubbery or elastomeric material via different means: e.g. by having a copolymer domain that holds other linear chains together. Each of these elastomers can be used to bond particles of a cathode active material by one of several means; e.g. spray coating, dilute solution mixing (dissolving the cathode active material particles in an uncured polymer, monomer, or oligomer, with or without an organic solvent) followed by drying and curing.

Saturated rubbers and related elastomers in this category include EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, and protein elastin. Polyurethane and its copolymers (e.g. urea-urethane copolymer) are particularly useful elastomeric shell materials for encapsulating anode active material particles.

The presently disclosed lithium secondary batteries can contain a wide variety of cathode active materials. The cathode active material layer may contain a cathode active material selected from an inorganic material, an organic material, a polymeric material, or a combination thereof. The inorganic material may be selected from a metal oxide, metal phosphate, metal silicide, metal selenide, transition metal sulfide, or a combination thereof.

The inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The cathode active material layer may contain a metal oxide containing vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The electrolyte used in the lithium battery may be a liquid electrolyte, polymer gel electrolyte, solid-state electrolyte (including solid polymer electrolyte, inorganic electrolyte, and composite electrolyte), quasi-solid electrolyte, ionic liquid electrolyte.

The liquid electrolyte or polymer gel electrolyte typically comprises a lithium salt dissolved in an organic solvent or ionic liquid solvent. There is no particular restriction on the types of lithium salt or solvent that can be used in practicing the present disclosures.

Some particularly useful lithium salts are lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

The lithium secondary battery may be a lithium-sulfur battery, wherein the cathode comprises a lithium polysulfide.

### EXAMPLE 1

### Anode-Less Lithium Battery Containing a High-Elasticity Polymer-Protected Anode

The ethoxylated trimethylopropane triacrylate monomer (ETPTA, Mw=428, Sigma-Aldrich) was dissolved in a solvent mixture of ethylene carbonate (EC)/diethyl carbonate (DEC), at a weight-based composition ratio of the ETPTA/solvent of 3/97 (w/w). Subsequently, benzoyl peroxide (BPO, 1.0 wt. % relative to the ETPTA content), along with a desired amount of selected flame retardant (e.g. a phosphorus compound, Formula 3 below, from Amfine Chemical Corp.), were added as a radical initiator to allow for thermal crosslinking reaction upon deposition on a Cu foil surface. This layer of ETPTA monomer/initiator was then thermally cured at 60° C. for 30 min to obtain a protective layer.

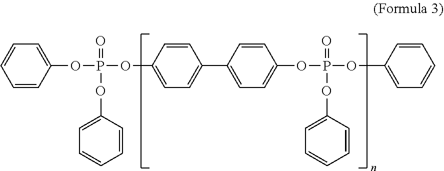

On a separate basis, some amount of the ETPTA monomer/solvent/initiator solution was cast onto a glass surface to form a wet film, which was thermally dried and then cured at 60° C. for 30 min to form a film of cross-linked polymer. In this experiment, the BPO/ETPTA weight ratio was varied from 0.1% to 4% to vary the degree of cross-linking in several different polymer films. Some of the cured polymer samples were subjected to dynamic mechanical testing to obtain the equilibrium dynamic modulus, Ge, for the determination of the number average molecular weight between two cross-link points (Mc) and the corresponding number of repeat units (Nc), as a means of characterizing the degree of cross-linking. The typical and preferred number of repeat units (Nc) is from 5 to 5,000, more preferably from 10 to 1,000, further preferably from 20 to 500, and most preferably from 50 to 500.

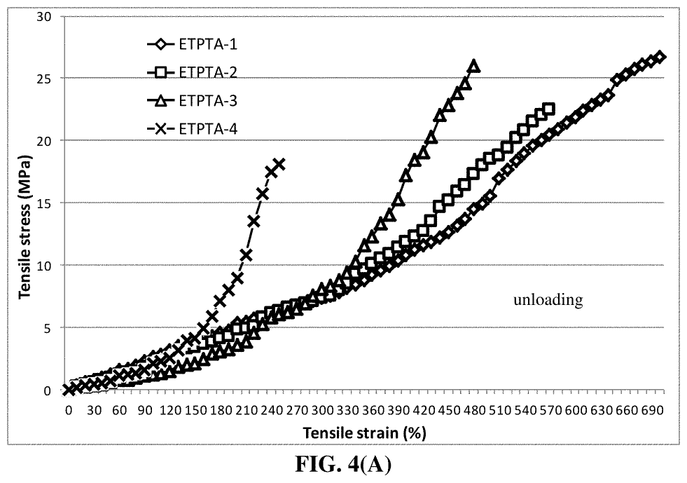

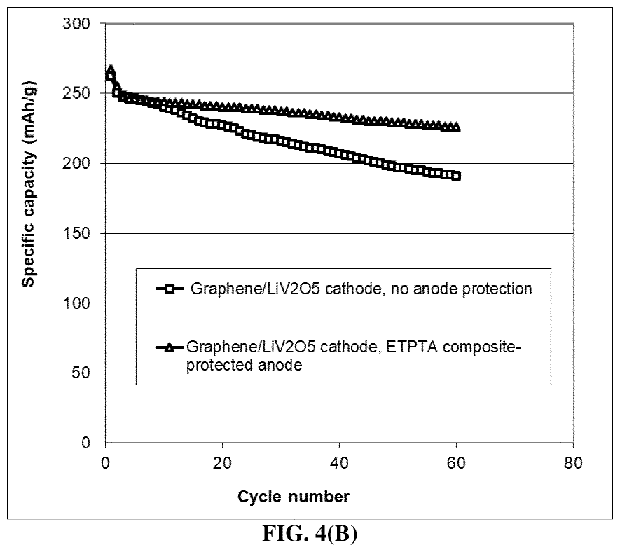

Several tensile testing specimens were cut from each cross-link film and tested with a universal testing machine. The testing results (FIG. 4), indicate that BPO-initiated cross-linked ETPTA polymers have an elastic deformation from approximately 230% to 700%. The above values are for neat polymers without any additive. The addition of up to 30% by weight of an additive typically reduces this elasticity down to a reversible tensile strain in the range from 10% to 120%.

For electrochemical testing, the working electrodes (cathode layers) were prepared by mixing 85 wt. % LiV₂O₅ or 88% of graphene-embraced LiV₂O₅ particles, 5-8 wt. % CNTs, and 7 wt. % polyvinylidene fluoride (PVDF) binder dissolved in N-methyl-2-pyrrolidinoe (NMP) to form a slurry of 5 wt. % total solid content. After coating the slurries on Al foil, the electrodes were dried at 120° C. in vacuum for 2 h to remove the solvent before pressing. Then, the electrodes were cut into a disk (ϕ=12 mm) and dried at 100° C. for 24 h in vacuum.

Electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-DEC, 1:1 v/v). The cell assembly was performed in an argon-filled glove-box. The CV measurements were carried out using a CH-6 electrochemical workstation at a scanning rate of 1 mV/s. The electrochemical performance of the cell featuring high-elasticity polymer binder and that containing PVDF binder were evaluated by galvanostatic charge/discharge cycling at a current density of 50 mA/g using an Arbin electrochemical workstation.

Summarized in FIG. 4(B) are the specific intercalation capacity curves of two lithium cells each having a cathode containing LiV₂O₅ particles (one cell having a retardant-filled cross-linked ETPTA polymer-based lithium metal anode-protecting layer and the other having no polymer protection). As the number of cycles increases, the specific capacity of the un-protected cells drops at the fastest rate. In contrast, the presently disclosed cross-linked ETPTA polymer protection layer provides the battery cell with a significantly more stable and high specific capacity for a large number of cycles. These data have clearly demonstrated the surprising and superior performance of the presently disclosed cross-linked ETPTA polymer protection approach.

The high-elasticity cross-linked ETPTA polymer protective layer appears to be capable of reversibly deforming to a great extent without breakage when the lithium foil decreases in thickness during battery discharge. The protective polymer layer also prevents the continued reaction between liquid electrolyte and lithium metal at the anode, reducing the problem of continuing loss in lithium and electrolyte. This also enables a significantly more uniform deposition of lithium ions upon returning from the cathode during a battery re-charge; hence, no lithium dendrite. These were observed by using SEM to examine the surfaces of the electrodes recovered from the battery cells after some numbers of charge-discharge cycles.

### EXAMPLE 2

### High-Elasticity Polymer Composite Layer Implemented in the Anode of a Lithium-LiCoO₂ Cell (Initially the Cell Being Lithium-Free)

The high-elasticity polymer for anode protection was based on cationic polymerization and cross-linking of the cyanoethyl polyvinyl alcohol (PVA-CN) in succinonitrile (SN). The procedure began with dissolving PVA-CN in succinonitrile to form a mixture solution. This step was followed by adding an initiator into the solution. For the purpose of incorporating some lithium species into the high elasticity polymer, we chose to use LiPF₆ as an initiator. The ratio between LiPF₆ and the PVA-CN/SN mixture solution was varied from 1/20 to 1/2 by weight to form a series of precursor solutions. A desired amount of a flame retardant (e.g. melamine-based flame retardant, from Italmatch Chemicals) was then added into the solution. Subsequently, these solutions were separately spray-deposited to form a thin layer of precursor reactive mass onto a Cu foil. The precursor reactive mass was then heated at a temperature from 75 to 100° C. for 2 to 8 hours to obtain a layer of high-elasticity polymer composite adhered to the Cu foil surface.

Additionally, some amount of the reacting mass, PVA-CN/LiPF₆, was cast onto a glass surface to form several films which were polymerized and cross-linked to obtain cross-linked polymers having different degrees of cross-linking. Tensile testing was also conducted on these films and this series of cross-linked polymers can be elastically stretched up to approximately 80% (higher degree of cross-linking) to 400% (lower degree of cross-linking).

Electrochemical testing results show that the cell having an anode-protecting polymer composite layer offers a significantly more stable cycling behavior. The high-elasticity polymer appears to act to isolate the liquid electrolyte from the subsequently deposited lithium coating, preventing continued reaction between the liquid electrolyte and lithium metal.

### EXAMPLE 3

### Li Metal Cells Containing a PETEA-Based High-Elasticity Polymer-Protected Anode

For preparing as an anode lithium metal-protecting layer, pentaerythritol tetraacrylate (PETEA), Formula 4, was used as a monomer:

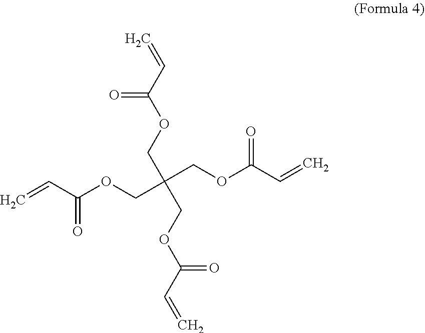 [SMILES: C=CC(=O)OCC(COC(=O)C=C)(COC(=O)C=C)COC(=O)C=C]

In a representative procedure, the precursor solution was composed of 1.5 wt. % PETEA (C₁₇H₂₀O₈) monomer and 0.1 wt. % azodiisobutyronitrile (AIBN, C₈H₁₂N₄) initiator dissolved in a solvent mixture of 1,2-dioxolane (DOL)/dimethoxymethane (DME)(1:1 by volume). The PETEA/AIBN precursor solution, along with a flame retardant (e.g. “Phoslite”, a Phosphorus compound, from Italmatch Chemicals) dispersed therein, was cast onto a lithium metal layer pre-deposited on a Cu foil surface to form a precursor film, which was polymerized and cured at 70° C. for half an hour to obtain a lightly cross-linked polymer.

Additionally, the reacting mass, PETEA/AIBN (without any additive), was cast onto a glass surface to form several films that were polymerized and cured to obtain cross-linked polymers having different degrees of cross-linking. Tensile testing was also conducted on these films and this series of cross-linked polymers can be elastically stretched up to approximately 25% (higher degree of cross-linking) to 80% (lower degree of cross-linking)

Commercially available NCM-532 powder (well-known lithium nickel cobalt manganese oxide), along with graphene sheets (as a conductive additive), was then added into an NMP and PVDF binder suspension to form a multiple-component slurry. The slurry was then slurry-coated on Al foil to form cathode layers.

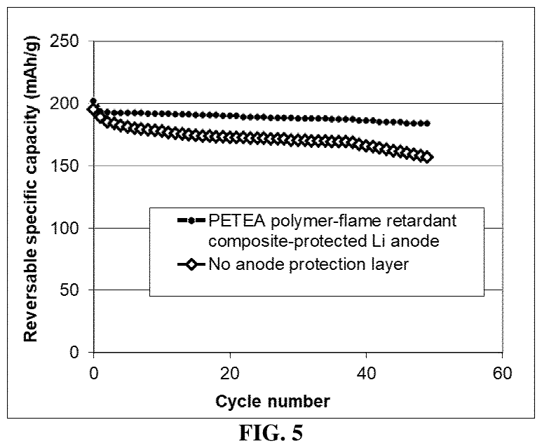

Shown in FIG. 5 are the discharge capacity curves of two coin cells having the same cathode active material, but one cell having a high-elasticity polymer composite-protected anode and the other having no protective layer. These results have clearly demonstrated that the high-elasticity polymer composite protection strategy provides excellent protection against capacity decay of an anode-less lithium metal battery.

The high-elasticity polymer composite appears to be capable of reversibly deforming without breakage when the anode layer expands and shrinks during charge and discharge. The polymer also prevents continued reaction between the liquid electrolyte and the lithium metal. No dendrite-like features were found with the anode being protected by a high-elasticity polymer. This was confirmed by using SEM to examine the surfaces of the electrodes recovered from the battery cells after some numbers of charge-discharge cycles.

### EXAMPLE 4

### Li Metal Cells Containing a Sulfonated Triblock Copolymer Poly(Styrene-Isobutylene-Styrene, or SIBS) Composite as an Anode Protective Layer

Both non-sulfonated and sulfonated elastomer composites were used to build an anode-protecting layer in the anode-less lithium cells. The sulfonated versions typically provide a much higher lithium ion conductivity and, hence, enable higher-rate capability or higher power density. The elastomer matrix can contain a lithium ion-conducting additive, in addition to the inorganic filler, if so desired.

An example of the sulfonation procedure used in this study for making a sulfonated elastomer is summarized as follows: a 10% (w/v) solution of SIBS (50 g) and a desired amount of an inorganic filler material (0 to 40.5% by wt.) in methylene chloride (500 ml) was prepared. The solution was stirred and refluxed at approximately 40° C., while a specified amount of acetyl sulfate in methylene chloride was slowly added to begin the sulfonation reaction. Acetyl sulfate in methylene chloride was prepared prior to this reaction by cooling 150 ml of methylene chloride in an ice bath for approximately 10 min. A specified amount of acetic anhydride and sulfuric acid was then added to the chilled methylene chloride under stirring conditions. Sulfuric acid was added approximately 10 min after the addition of acetic anhydride with acetic anhydride in excess of a 1:1 mole ratio. This solution was then allowed to return to room temperature before addition to the reaction vessel.

After approximately 5 h, the reaction was terminated by slowly adding 100 ml of methanol. The reacted polymer solution was then precipitated with deionized water. The precipitate was washed several times with water and methanol, separately, and then dried in a vacuum oven at 50° C. for 24 h. This washing and drying procedure was repeated until the pH of the wash water was neutral. After this process, the final polymer yield was approximately 98% on average. This sulfonation procedure was repeated with different amounts of acetyl sulfate to produce several sulfonated polymers with various levels of sulfonation or ion-exchange capacities (IECs). The mol % sulfonation is defined as: mol %=(moles of sulfonic acid/moles of styrene)×100%, and the IEC is defined as the mille-equivalents of sulfonic acid per gram of polymer (mequiv./g).

After sulfonation and washing of each polymer, the S-SIBS samples were dissolved in a mixed solvent of toluene/hexanol (85/15, w/w) with concentrations ranging from 0.5 to 2.5% (w/v). Desired amounts of a flame retardant (aluminum hydroxide and magnesium hydroxide) were then added into the solution to form slurry samples. The slurry samples were slot-die coated on a PET plastic substrate to form layers of sulfonated elastomer composite. These flame retardants were found to have insignificant impact on the lithium ion conductivity.

### EXAMPLE 5

### Elastic Polyurethane Elastomer Containing Particles of a Flame Retardant Additive

Twenty tour parts by weight of diphenylmethane diisocyanate and 22 parts by weight of butylene glycol were continuously^{,} reacted with 100 parts by weight of polyethylene adipate having hydroxyl groups at both terminals (molecular weight of 2,100) with agitation at a reaction temperature of 115° C., for a reaction time of 60 minutes to give a prepolymer having hydroxyl-terminal. This prepolymer having hydroxyl-terminal had a viscosity of 4,000 cP at 70° C.

On a separate basis, 84 parts by weight of diphenylmethane diisocyanate was continuously reacted with 200 parts by weight of polyethylene adipate having hydroxyl groups at both terminals (molecular weight of 2,100) with agitation at a reaction temperature of 115° C. for a reaction time of 60 minutes to give a prepolymer having isocyanate-terminal. This prepolymer having isocyanate-terminal had a viscosity of 1,500 cP at 70° C.

One hundred forty six (146) parts by weight of the thus obtained prepolymer having hydroxyl-terminal and 284 parts by weight of the obtained prepolymer having isocyanate-terminal, along with a desired amount of a selected flame retardant additive (reactive polysiloxane from Evonik)), were continuously injected into a heat exchange reactor and mixed and stirred at a reaction temperature of 190° C. for a residence time of 5-30 minutes. The obtained. viscous product was immediately cast onto a glass surface to obtain a layer of elastic polymer composite having a thickness of approximately 51 nm, 505 nm, and 2.2 μm, respectively.

On a separate basis, a sample of reactive polysiloxane was cast onto a glass surface and cured at 115° C. for 2 hours to form elastic polymer composite film of 8-45 μm in thickness. The lithium ion conductivity of these thin films was approximately 2-5 10⁻⁵ S/cm.

### EXAMPLE 6

### Lithium Battery Containing a High-Elasticity UHMW Polymer-Protected Lithium Anode and a Cathode Containing V₂O₅ Particles

Cathode active material layers were prepared from V₂O₅ particles and graphene-embraced V₂O₅ particles, respectively. The V₂O₅ particles were commercially available. Graphene-embraced V₂O₅ particles were prepared in-house. In a typical experiment, vanadium pentoxide gels were obtained by mixing V₂O₅ in a LiCl aqueous solution. The Litexchanged gels obtained by interaction with LiCl solution (the Li:V molar ratio was kept as 1:1) was mixed with a GO suspension and then placed in a Teflon-lined stainless steel 35 ml autoclave, sealed, and heated up to 180° C. for 12 h. After such a hydrothermal treatment, the green solids were collected, thoroughly washed, ultrasonicated for 2 minutes, and dried at 70° C. for 12 h followed by mixing with another 0.1% GO in water, ultrasonicating to break down nano-belt sizes, and then spray-drying at 200° C. to obtain graphene-embraced V₂O₅ composite particulates. Selected amounts of V₂O₅ particles and graphene-embraced V₂O₅ particles, respectively, were then each made into a cathode layer following a well-known slurry coating process.

UHMW PEO-based high-elasticity polymer layer for lithium metal protection was prepared according to the following procedure: UHMW PEO was dissolved in DI-water (1.6 wt. %) to form a homogenous and clear solution first. Then, a lithium salt (1-40% LiClO₄) and 1-20% by weight of carboxylic acid (as a flame retardant) were added to the PEO solution to form a series of slurries. The slurries were separately cast onto glass surfaces to form films, which were dried to form various UHMW PEO films containing lithium salt and/or an electron-conducting material graphene oxide sheets). The UHMW polymer film thickness was varied from 0.45 to 1.88 μm.

UHMW PEO-water solution was also cast onto glass surface and dried to form PEO films. Upon thorough drying, the polymer films were soaked in a desired solvent (e.g. EC) to form a rubber-like polymer. Several tensile testing specimens were cut from each polymer film containing a solvent (e.g. EC) and tested with a universal testing machine. This polymer has an elastic deformation of approximately 30-150%. This value is for a neat polymer (containing some solvent) without any solid additive (no lithium salt and no additive). The addition of up to 40% by weight of a lithium salt and/or additive typically reduces this elasticity down to a reversible tensile strain from 5% to 60%.

### EXAMPLE 7

### High-Elasticity Polymer Implemented in the Anode of a Lithium-LiCoO₂ Cell (Initially the Cell Being Lithium-Free)

The high-elasticity polymer for anode layer protection in a Li—LiCoO₂ cell was based on ultra-high molecular weight polyacrylonitrile (UHMW PAN). UHMW PAN (0.3 g) was dissolved in 5 ml of dimethylformamide (DMF) to form a solution. Some LiPF₆ salt (5% by weight) and some flame retardant (7% red phosphorus-based) were then dispersed in the solution to form a slurry. The slurries were then separately cast and dried to form polymer films.

Polymer films for elasticity testing were cast from the prepared solutions on a glass support, followed by solvent evaporation at 70° C. under a fume hood. To remove the traces of DMF, the films were thoroughly dried in a vacuum (<1 Torr) at 70° C. for 48h. The polymer films were soaked in propylene carbonate (PC) to form PC-plasticized UHMW PAN films. This series of polymers can be elastically stretched up to approximately 80%. The high-elasticity polymer composite can act to isolate the electrolyte from the lithium coating yet still allowing for easy diffusion of lithium ions. The flame retardant dispersed therein provides additional protection against internal shorting-induced fire hazard.

### EXAMPLE 8

### Effect of Lithium Ion-Conducting Additive in a High-Elasticity Polymer

A wide variety of lithium ion-conducting or flame retardant additives were added to several different polymer matrix materials to prepare anode protection layers. The lithium ion conductivity vales of the resulting polymer/salt complex materials are summarized in Table 1 below. We have discovered that these polymer composite materials are suitable anode-protecting layer materials provided that their lithium ion conductivity at room temperature is no less than 10⁻⁶ S/cm. With these materials, lithium ions appear to be capable of readily diffusing through the protective layer having a thickness no greater than 1μm. For thicker polymer films (e.g. 10 μm), a lithium ion conductivity at room temperature of these high-elasticity polymers no less than 10⁻⁴ S/cm would be required.

TABLE 1
Lithium ion conductivity of various high-elasticity polymer composite compositions.

| Sample | | | |
|---|---|---|---|
| No. | Additive | Elastomer (1-2 μm thick) | Li-ion conductivity (S/cm) |
| E-1b | Aluminum hydroxide | 70-99% PVA-CN | 2.4 × 10⁻⁴ to 2.8 × 10⁻³ S/cm |
| E-2b | aluminum diethyl | 65-99% ETPTA | 2.4 × 10⁻⁴ to 1.3 × 10⁻³ S/cm |
| | phosphinate | | |
| E-3b | Li₂CO₃ + (CH₂OCO₂Li)₂ | 65-99% ETPTA/EGMEA | 8.4 × 10⁻⁴ to 1.8 × 10⁻³ S/cm |
| D-4b | Li₂CO₃ + (CH₂OCO₂Li)₂ | 70-99% PETEA | 7.8 × 10⁻³ to 2.3 × 10⁻² S/cm |
| D-5b | Li₂CO₃ + (CH₂OCO₂Li)₂ | 75-99% PVA-CN | 8.9 × 10⁻⁴ to 5.5 × 10⁻³ S/cm |
| B1b | LiF + LiOH + Li₂C₂O₄ | 60-90% PVA-CN | 8.7 × 10⁻⁵ to 2.3 × 10⁻³ S/cm |
| B2b | LiF + HCOLi | 80-99% PVA-CN | 2.8 × 10⁻⁴ to 1.6 × 10⁻³ S/cm |
| B3b | chlorinated paraffins | 70-99% PETEA | 9.7 × 10⁻⁴ to 2.5 × 10⁻³ S/cm |
| B4b | triphenyl phosphate | 70-99% PETEA | 1.4 × 10⁻³ to 3.2 × 10⁻³ S/cm |
| B5b | Li₂C₂O₄ | 70-99% PETEA | 1.3 × 10⁻³ to 1.2 × 10⁻² S/cm |
| B6b | Li₂CO₃ + LiOH | 70-99% PETEA | 1.4 × 10⁻³ to 1.6 × 10⁻² S/cm |
| C1b | LiClO₄ | 70-99% PVA-CN | 4.5 × 10⁻⁴ to 2.4 × 10⁻³ S/cm |
| C2b | LiPF₆ | 70-99% PVA-CN | 3.4 × 10⁻⁴ to 7.2 × 10⁻³ S/cm |
| C3b | LiBF₄ | 70-99% PVA-CN | 1.1 × 10⁻⁴ to 1.8 × 10⁻³ S/cm |
| C4b | LiBOB + LiNO₃ | 70-99% PVA-CN | 2.2 × 10⁻⁴ to 4.3 × 10⁻³ S/cm |
| S1b | Sulfonated polyaniline | 85-99% ETPTA | 9.8 × 10⁻⁵ to 9.2 × 10⁻⁴ S/cm |
| S2b | Sulfonated SBR | 85-99% ETPTA | 1.2 × 10⁻⁴ to 1.0 × 10⁻³ S/cm |
| S3b | Sulfonated PVDF | 80-99% ETPTA/EGMEA | 3.5 × 10⁻⁴ to 2.1 × 10⁻⁴ S/cm |
| S4b | Polyethylene oxide | 80-99% ETPTA/EGMEA | 4.9 × 10⁻⁴ to 3.7 × 103⁴ S/cm |

In conclusion, the high-elasticity polymer composite-based anode-protecting layer strategy is surprisingly effective in alleviating the problems of lithium metal dendrite formation and lithium metal-electrolyte reactions that otherwise lead to capacity decay and potentially internal shorting and explosion of the lithium secondary batteries. The high-elasticity polymer composite is capable of expanding or shrinking congruently or conformably with the anode layer. This capability helps to maintain a good contact between the current collector (or the deposited lithium film during the charging procedure) and the protective layer, enabling uniform re-deposition of lithium ions without interruption. The flame retardant in the polymer provides another level of protection against any combustion or fire hazards.

We claim:

1. A lithium secondary battery comprising a cathode, an anode, and an electrolyte or separator-electrolyte assembly disposed between said cathode and said anode, wherein said anode comprises:
a) An anode current collector; and
b) a thin layer of a high-elasticity polymer composite in ionic contact with said electrolyte and disposed between said anode current collector and said electrolyte wherein said polymer composite comprises from 0.01% to 95% by weight of a flame retardant additive dispersed in, dissolved in, or chemically bonded to an elastic polymer and said polymer composite has a thickness from 2 nm to 100 μm, a fully recoverable tensile strain from 2% to 700%, and a lithium ion conductivity from 10⁻⁸ S/cm to 5×10⁻² S/cm.

2. The lithium secondary battery of claim 1, wherein initially the anode has no lithium or lithium alloy as an anode active material supported by said anode current collector when the battery is made and prior to a charge or discharge operation of the battery.

3. The lithium secondary battery of claim 1, wherein the anode has an amount of lithium or lithium alloy as an anode active material supported by said anode current collector when the battery is made.

4. The lithium secondary battery of claim 1, wherein said flame retardant additive is selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

5. The lithium secondary battery of claim 1, wherein said electrolyte is selected from an organic liquid electrolyte, ionic liquid electrolyte, polymer gel electrolyte, solid-state electrolyte, quasi-solid electrolyte having a lithium salt dissolved in an organic or ionic liquid with a lithium salt concentration higher than 2.0 M, hybrid or composite electrolyte, or a combination thereof.

6. The lithium secondary battery of claim 5, wherein said solid-state electrolyte is selected from a polymer type, an oxide type, sulfide type, hydride type, halide type, borate type, phosphate type, lithium phosphorus oxynitride (UPON), Garnet-type, lithium superionic conductor (LISICON) type, sodium superionic conductor (NASICON) type, or a combination thereof.

7. The lithium secondary battery of claim 1, wherein said high-elasticity polymer contains a cross-linked network of polymer chains having an ether linkage, nitrile-derived linkage, benzo peroxide-derived linkage, ethylene oxide linkage, propylene oxide linkage, vinyl alcohol linkage, cyano-resin linkage, triacrylate monomer-derived linkage, tetraacrylate monomer-derived linkage, or a combination thereof in said cross-linked network of polymer chains.

8. The lithium secondary battery of claim 1, wherein said elastic polymer contains a cross-linked network of polymer chains selected from nitrile-containing polyvinyl alcohol chains, cyanoresin chains, pentaerythritol tetraacrylate chains, pentaerythritol triacrylate chains, ethoxylated trimethylolpropane triacrylate (ETPTA) chains, ethylene glycol methyl ether acrylate (EGMEA) chains, or a combination thereof.

9. The lithium secondary battery of claim 1, wherein said elastic polymer comprises an elastomer selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, polyurethane, urethane-urea copolymer, urethane-acrylic copolymer, a copolymer thereof, a sulfonated version thereof, or a combination thereof.

10. The lithium secondary battery of claim 1, wherein said elastic polymer comprises an ultra-high molecular weight polymer, having a molecular weight greater than 500,000 g/mole, selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

11. The lithium secondary battery of claim 1, wherein said elastic polymer composite comprises reactive type flame retardant, additive type flame retardant, or both types.

12. The lithium secondary battery of claim 1, wherein said elastic polymer composite comprises a flame retardant group bonded polysiloxane.

13. The lithium secondary battery of claim 1, wherein said elastic polymer further comprises from 0.1% to 50% by weight of a lithium ion-conducting additive, which is different from the flame retardant additive in composition or structure.

14. The lithium secondary battery of claim 1, wherein said elastic polymer further comprises a reinforcement material dispersed therein wherein the reinforcement material is selected from a polymer fiber, a glass fiber, a ceramic fiber or nano-flake, a graphene sheet, a carbon fiber, a graphite fiber, a carbon nano-fiber, a graphite nano-fiber, a carbon nanotube, a graphite particle, an expanded graphite flake, an acetylene black particle, or a combination thereof.

15. The lithium secondary battery of claim 13, wherein said lithium ion-conducting additive contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

16. The lithium secondary battery of claim 13, wherein said lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4.

17. The lithium secondary battery of claim 1, wherein the high-elasticity polymer forms a mixture or blend with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

18. The lithium secondary battery of claim 1, wherein said cathode comprises a cathode active material selected from an inorganic material, an organic material, a polymeric material, or a combination thereof.

19. The lithium secondary battery of claim 18, wherein said inorganic material, as a cathode active material, is selected from a metal oxide, metal phosphate, metal silicide, metal selenide, transition metal sulfide, or a combination thereof.

20. The lithium secondary battery of claim 18, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

21. The lithium secondary battery of claim 18, wherein said inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

22. The lithium secondary battery of claim 19, wherein said metal oxide contains a vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1<x<5.

23. The lithium secondary battery of claim 19, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

24. An anode electrode for use in a lithium metal battery, said anode comprising:
a) An anode current collector; and
b) a thin layer of a high-elasticity polymer composite in ionic contact with said electrolyte and disposed between said anode current collector and said electrolyte wherein said polymer composite comprises from 0.01% to 95% by weight of a flame retardant dispersed in, dissolved in, or bonded to an elastic polymer and said polymer composite has a thickness from 2 nm to 100 μm, a fully recoverable tensile strain from 2% to 700%, and a lithium ion conductivity from 10⁻⁸ S/cm to 5×10⁻² S/cm.

25. A method of manufacturing the anode electrode of claim 24, the method comprising (A) providing an anode current collector having two primary surfaces; and (B) depositing a thin layer of a high-elasticity polymer composite onto at least one of the two primary surfaces of said anode current collector wherein said polymer composite comprises from 0.01% to 95% by weight of a flame retardant additive dispersed or dissolved in an elastic polymer and said polymer composite has a thickness from 2 nm to 100 μm, a fully recoverable tensile strain from 2% to 700%, and a lithium ion conductivity from 10⁻⁸ S/cm to 5×10⁻² S/cm.

26. The method of claim 25, further comprising a step (C) of depositing a desired amount of lithium metal or lithium metal alloy on at least one of the two primary surfaces before step (B).

27. The method of claim 25, wherein said step (B) comprises (i) dispersing said flame retardant additive in a liquid reactive mass of the elastic polymer precursor to form a slurry; (ii) dispensing and depositing said liquid reactive mass onto said at least one primary surface; and (iii) curing said reactive mass to form said layer of high-elasticity polymer composite.

28. The method of claim 25, further comprising combining an electrolyte and a cathode electrode to form a lithium battery.
